(19) United States
(12) Patent Application Publication
(10) Pub. No.: US 2025/0290468 A1
(43) Pub. Date: Sep. 18, 2025

(54) ROTODYNAMIC FLUID TRANSFER AND ENERGY EXTRACTION DEVICE WITH SHAFTLESS ROTATIONAL COUPLING AND CONSTRAINT AS USED IN ROCKET PROPULSION SYSTEMS

(71) Applicant: VAYA SPACE, INC., Cocoa, FL (US)

(72) Inventors: Carson ZIDE, Cocoa, FL (US); Carlos E PADILLA HERRERA, Cocoa, FL (US); Kineo M. WALLACE, Cocoa, FL (US); Piotr BACZAR, Cocoa, FL (US); Brian K DEYO, Cocoa, FL (US)

(73) Assignee: VAYA SPACE, INC., Cocoa, FL (US)

(21) Appl. No.: 19/079,224

(22) Filed: Mar. 13, 2025

Related U.S. Application Data
(60) Provisional application No. 63/564,842, filed on Mar. 13, 2024.

(51) Int. Cl. F02K 9/48; F01D 15/08

(52) U.S. Cl. CPC F02K 9/48; F01D 15/08; F05D 2240/24; F05D 2240/51; F05D 2240/55

(57) ABSTRACT

Turbopump assemblies and pump turbine assemblies utilized in rocket propulsion systems or other systems are disclosed. The turbopump assembly may include a rotor with at least one integral pump impeller and at least one integral turbine impeller, a housing containing the rotor, and first and second bearings supporting the rotor. The first and second bearings are supported by the housing. The rotor is disposed between the first and second bearings such that the at least one integral pump impeller and the at least one integral turbine impeller are supported between the first and second bearings. At least one integral pump impeller and at least one integral turbine impeller are provided between all bearings supporting the pump and turbine in the housing.

This non-provisional application claims the benefit under 35 U.S.C. § 119(e) to U.S. Provisional Application No. 63/564,842, filed on Mar. 13, 2024, which is hereby expressly incorporated by reference into the present application.

### BACKGROUND

Conventional rotodynamic pumping systems 100 consist of a high-speed turbine 120 and pump rotor 110 interconnected by a drive shaft assembly, typically with a shaft 140 such as illustrated in Prior Art FIG. 1. A pump 110 and a turbine 120 are mounted to the drive shaft 140 which rotates in bearings 130. One potential problem of such a configuration is that the operating speed typically used to produce high pressure flows often subjects the drive shaft 140 to vibrational instabilities, causing the drive shaft 140 to experience instantaneous deformation. The turbopump therefore may have harmonic instabilities at intermediate speeds encountered when spinning up to operating speeds. Jumping through this harmonic instability can cause damage or deformation of the drive shaft 140. For this reason, traditional turbopumps use a spin start to cause the rotor to go from zero to thousands of rpms in less than one second. This causes strain on the system due to high acceleration but can prevent the harmonic instabilities from causing the rotor to shake apart as it goes through these instabilities. The attachment of the pump 110 and turbine 120 with a drive shaft 140 typically enhances such harmonic instabilities as the drive shaft 140 may work like a harmonic string. Rapid acceleration may also cause the drive shaft 140 to twist due to the acceleration.

These harmonic instabilities are caused by harmonic modes which critically affect the operational stability and efficiency of the system 100, potentially causing catastrophic component failure. In such a conventional pumping system, the drive shaft 140 is mounted to bearings 130 between the pump 110 and turbine 120 producing a configuration that makes the drive shaft 140 relatively long, thus subjecting the drive shaft 140 to relatively high stress and extreme conditions thereby demanding extreme precision and part perfection in their construction in order to reduce the risks of failure. In particular, a high degree of balance is required between the pump 110 and turbine 120 to avoid wobble in the assembly as it accelerates and spins. FIG. 1 further shows schematically the pump input 112 and pump output 114 as well as the turbine input 124 and turbine output 122. The turbopump may be housed in a shroud or housing as is well known.

In part due to the high rotational speed of the pumping systems typically used, the assembly of the conventional art (pump 110, drive shaft 140/bearings 130, and turbine 120) requires high tolerance machining as at the aforementioned high speeds minute differences in the tolerance stack up between each of the components which results in rotational instabilities due to uneven masses, misalignment, etc. This results in longer manufacturing times, higher costs, and longer lead times. Additionally, the inclusion of a drive shaft 140 for rotational translation and constraint increases the length of the overall assembly requiring the housing to be longer increasing weight as well as packaging difficulty.

Such conventional pumping systems 100 typically require that seals be placed between pump, drive shaft, and turbine to prevent fluid leakage. Additionally, if a designer desires the addition of an electric motor this too must be isolated with seals. Sealing such a highspeed rotodynamic machine is quite difficult and in most cases is not perfect due to the high loads and frictional forces on the seals. This increases losses in the system and decreases the efficiency. Additionally, in some cases this is resolved by using a helium buffer bleed between the two regions that must be separated. For example, when the pump 110 and the turbine 120 are driving and driven by the same fluid, respectively, it is possible to use a helium buffer bleed with a non-contact labyrinthine seal to prevent pressure leakage. These further increase the complexity of the machine increasing the chances of failures, increasing the cost, and further making the assembly longer and heavier.

### SUMMARY

In at least one example embodiment, a turbopump assembly in a rocket propulsion system is disclosed. In one embodiment, the turbopump assembly includes a rotor with at least one integral pump impeller and at least one integral turbine impeller, a housing containing the rotor, and first and second bearings supporting the rotor. The first and second bearings are supported by the housing. The rotor is disposed between the first and second bearings such that the at least one integral pump impeller and the at least one integral turbine impeller are supported between the first and second bearings. And the at least one integral pump impeller and at least one integral turbine impeller are between all bearings supporting the pump and turbine in the housing.

In at least one example embodiment, the pump turbine assembly includes a pump with a pump impeller, a turbine with a turbine impeller, and a housing supporting the pump impeller and turbine impeller. The pump impeller is arranged such that energy of rotation of the pump impeller is imparted directly to the turbine impeller without any intermediary rotational device positioned therebetween.

In at least one example embodiment, the pump and turbine impellers are interconnected to each other to translate rotation therebetween without a rotary drive shaft positioned therebetween.

In at least one example embodiment, a turbopump assembly includes magnets, coupling the turbine and pump without the need for a direct structural coupling.

In at least one example embodiment, the turbopump assembly includes an electromagnetic motor provided between the turbine and pump.

In at least one example embodiment, the turbopump assembly includes a magnetic gearbox coupling the turbine and the pump.

### BRIEF DESCRIPTION OF THE DRAWINGS

A brief description of the figures follows, where:

FIG. 1 is a schematic representation of a traditional turbopump design of the prior art having a relatively long drive shaft supported by bearings intermediate between the pump and turbine;

FIG. 2A is a schematic representation of a first example embodiment of a turbopump produced according to the principals of the present application with a portion cut away;

FIG. 2B is a schematic representation of the first example embodiment of a turbopump produced according to the principals of the present application with a portion cut away;

FIG. 2C is a schematic representation of the first example embodiment of a turbopump produced according to the principals of the present application with a portion cut away;

FIG. 2D is a schematic representation of the first example embodiment of a turbopump produced according to the principals of the present application with a portion cut away;

FIG. 2E is a schematic representation of the first example embodiment of a turbopump produced according to the principals of the present application with a portion cut away;

FIG. 2F is a schematic representation of the first example embodiment of a turbopump produced according to the principals of the present application with a portion cut away;

FIG. 3 is a schematic representation of a second example embodiment of a turbopump produced according to the principals of the present application with a portion cut away;

FIG. 4 is a schematic representation of a third example embodiment of a turbopump produced according to the principals of the present application with a portion cut away;

FIG. 5 is a schematic representation of a fourth example embodiment of a turbopump produced according to the principals of the present application with a portion cut away;

FIG. 6 is a schematic representation of a fifth example embodiment of a turbopump produced according to the principals of the present application with a portion cut away;

FIG. 7 is a schematic representation of a housing for rotodynamic components produced according to the principals of the present application;

FIG. 8 is a schematic representation of the housing for rotodynamic components produced according to the principals of the present application; and

FIG. 9 is a representation of the housing for rotodynamic components with the turbopump inside the housing produced according to the principals of the present application.

### Detailed Description of Example Embodiments

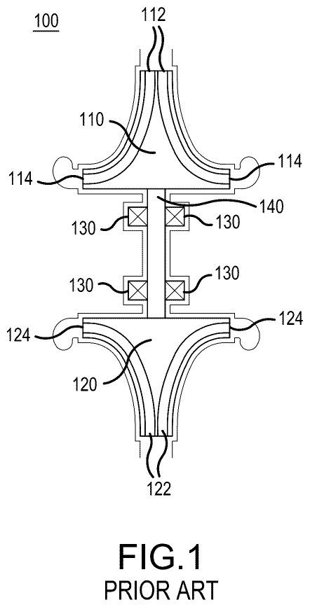

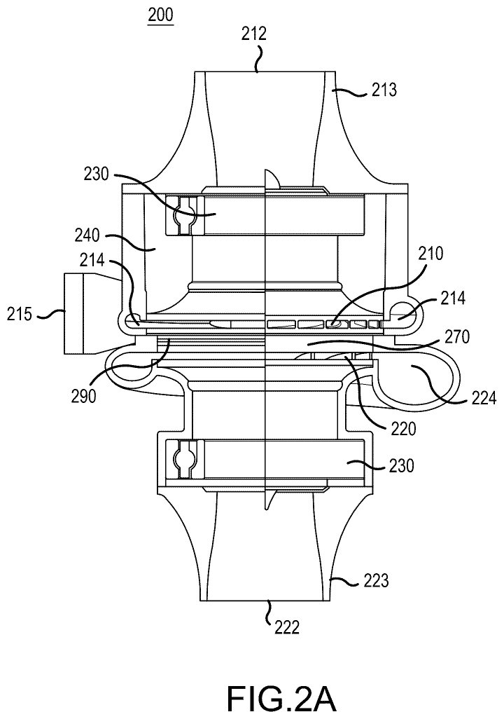

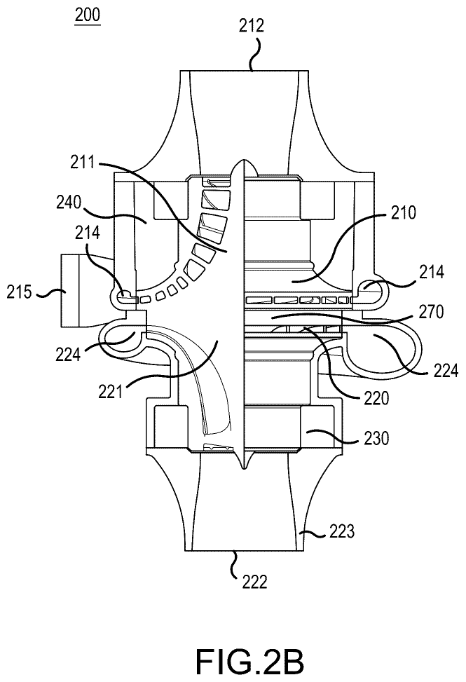

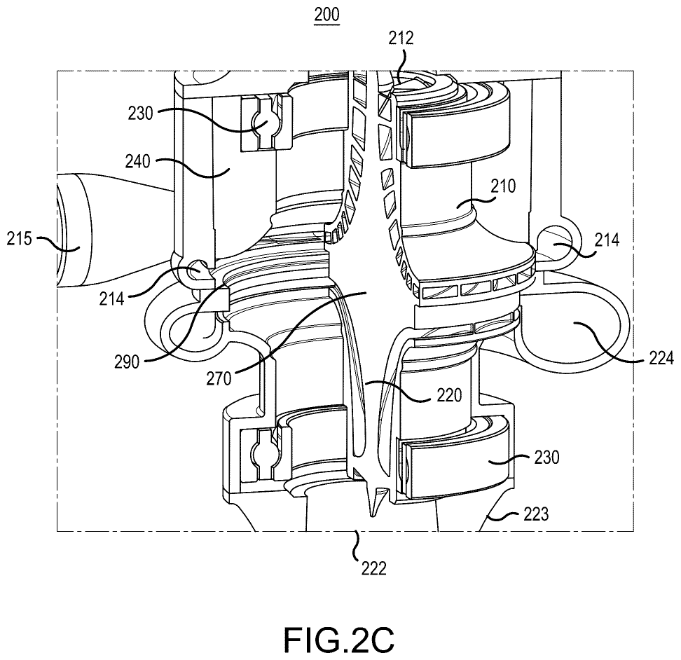

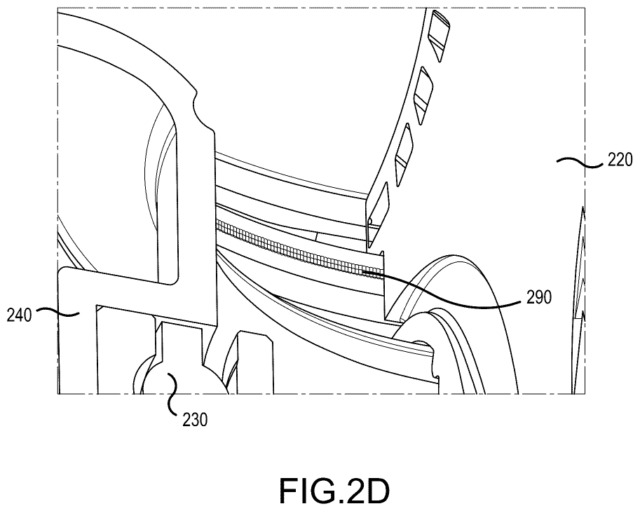

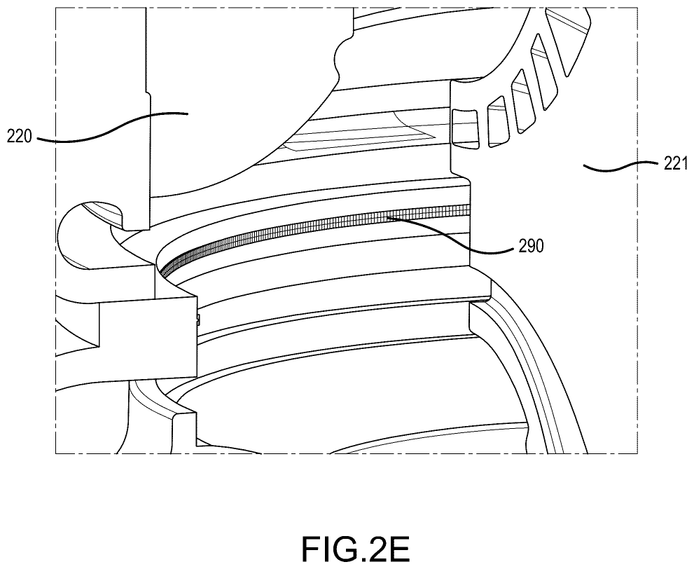

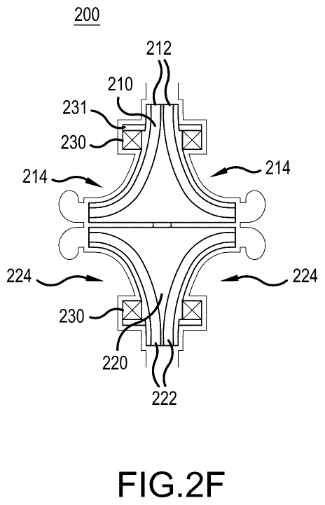

According to the teachings of the present application, the turbine and pump impellers may be integrated onto a one-piece rotor with shroud mounted bearings, removing the drive shaft with bearings intermediate the turbine and pump impellers, which is a weak point of legacy turbopump technology. An example of this construction is illustrated in FIGS. 2A-F. A pump 210 and a turbine 220 may be disposed adjacently without a separate drive shaft such as the drive shaft 140 of the FIG. 1 Prior Art. Traditional turbopump impeller assemblies such as FIG. 1 appear “bar bell” shaped, with relatively drive shafts 140 supported by bearings 130 located intermediate the pump and impeller. In accordance with the teachings of the present application, the bearings 230 are mounted with the pump 210 and turbine 220 positioned therebetween, thereby avoiding a separate drive shaft 130 and bearings 130 located between the pump and turbine as illustrated in Prior Art FIG. 1.

FIG. 2A is a schematic representation of a first example embodiment of a turbopump 200 (rotodynamic device) produced according to the principals of the present application with a portion cut away. FIG. 2B is a schematic representation of the first example embodiment of a turbopump 200 produced according to the principals of the present application with a portion cut away. FIG. 2C is a schematic representation of the first example embodiment of a turbopump 200 produced according to the principals of the present application with a portion cut away. FIG. 2D is a schematic representation of the first example embodiment of a turbopump 200 produced according to the principals of the present application with a portion cut away. FIG. 2E is a schematic representation of the first example embodiment of a turbopump 200 produced according to the principals of the present application with a portion cut away. And FIG. 2F is a schematic representation of the first example embodiment of a turbopump 200 produced according to the principals of the present application with a portion cut away. In the FIGS. 2A-2F, the bearings 230 are mounted on either end of a housing or shroud 240 and support both the pump 210 and turbine 220.

The pump 210 including a pump impeller 211 which rotates. The turbine including a turbine impeller 221 which rotates. With the mounted bearing configuration where the bearings 230 are located outside the pump and turbine, the intermediate drive shaft component 140 with its tendency to flex and possibly break is thus avoided. To avoid flexing and breaking the drive shaft 140 can be thickened, however this increases the weight of the drive shaft 140 and erode performance of the turbopump 100. The bearings 230 on the pump may be first bearings and the bearings on the turbine 230 may be second bearings. The bearing 230 may be a mechanical device that constrains the motion of the rotor such that it can only move rotationally while also reducing or preventing losses due to friction. The bearings 230 may be magnetic bearings which use magnetic fields to constrain the motion of the rotor. Magnetic bearings include a component on the rotating element and the stationary element with no contact (or minimal contact) between the two components. Thus, friction is greatly reduced compared to no bearings or even metal bearings which include contact between the components. If magnetic bearings are used, the bearing components may be mounted to both the housing and rotor. A bearing locator, which is a type of tensioning device, may be used to pull the rotor dynamic assembly into tension. Alternatively, the bearings may be fluidic or hydraulic bearings or any other suitable bearing for allowing the rotation of the drive shaft while constraining its location.

The resulting geometry, as illustrated in FIGS. 2A-F, dramatically improves the design's rotodynamic, thermodynamic, and structural dynamic stability while also reducing complexity, mass, volume, and total part count. The lack of a drive shaft allows the moment of inertia for the turbine 220 and pump 210 to be closer to the center of mass of the rotor. Thus, rotation of the turbopump 200 while the rotor is spinning (such as occurs when a rocket moves in a parabolic or other similar path) causes the gyroscopic forces to be reduced, placing less strain on the housing 240 of the turbopump 200. The closer moment of inertial also allows for the turbopump 200 to have greater tolerance for imbalance in the turbine impeller 221 and pump impeller 211 and the rotor in general.

The pump 210 may include and pump inlet 212 and pump outlet 214 which are connected such that fluids can pass through the pump 210 (as shown in FIG. 2B). A propellent outlet 215 may also be included. The pump inlet 212 may be defined in a pump inlet housing 213.

The turbine 220 may include a turbine inlet 224 and a turbine outlet (drive fluid outlet) 222 which are connected such that fluid can pass through the turbine 220 (as shown more clearly in FIG. 2B). The turbine outlet 222 may be defined in a turbine outlet housing 213. The pump inlet housing 213 and pump outlet housing 223 may be portions of the housing 240 of the turbopump.

Mounting the bearings 230 to the shroud 240 of the pump 210 and turbine 220 allows an integral rotor design that reduces both mass and volume while maximizing the mechanical efficiency metrics by reducing rotodynamic and vibrational losses. This allows for safer, more stable operation, reduces system complexity, and cuts manufacturing costs as compared to prior designs.

The disclosed embodiments allow for dynamic system scalability, stability, and flexibility not currently afforded by the configurations of the prior art as will be seen in the disclosed embodiments.

The components of the embodiments produced according to the teachings of the present application may be subdivided into two types of components, static structural and dynamic rotational elements. A main structural support element is the housing 240 configured to hold the rotor bearing assembly during operation while also providing hydrodynamically efficient inlet and outlet scrolls for the turbine 220 and pump 210, respectively. The housing 240 may be designed to evenly distribute the vibrational and dynamic loads that the rotor bearing assembly 230 imparts on the structure during operation. The rotational elements include the rotational elements of the bearings 230 as would be understood by one in the art as well as the pump and turbine rotational elements (rotors) which are identified as the pump 210 and turbine 220 in the drawing Figures. The rotational parts of the bearings 230 and the pump 210 and turbine 220 rotors collectively form a bearing rotor assembly. This assembly includes the rotational elements of the two bearings 230 situated such that the inner race of the bearing 230 interfaces and translates forces from the integral pump 210 and turbine 220 rotational elements to the housing or shroud 240 surrounding this integral rotor. The joint 270 between the pump 210 and the turbine 220 may take various forms. In the example embodiment of FIGS. 2A-2F, the pump 210 and the turbine 220 may be formed of a single piece of 3-d printed metal so the joint is a continuation of the 3-d printed metal. In other example embodiments the joint may include adhesives, pegs, screws and/or other joining materials.

On an exterior of the pump 210 and the turbine 220, at the joint 270 between the pump 210 and turbine 220 there may be a fluid-dynamic seal 290 that prevents fluids from passing from the pump 210 to the turbine 220. The pump 210 and turbine 220 may each have a solid wall or similar structure at or proximate to the fluid-dynamic seal 290 as illustrated in FIG. 2D. The pump 210 and turbine 220 may be in direct contact via the fluid dynamic seal 290 such that the pump 210 and turbine 220 rotate together at the same rotational velocity. The fluidic regions of the pump 210 and the turbine 220 may not be physically isolated by only divided by the fluid-dynamic seal 290.

The housing 240 is designed to secure the rotor bearing assembly. The rotor bearing assembly may include bearings 230. During operation the housing 240 may be configured to provide hydrodynamically efficient inlet and outlet scrolls for the turbine 220 and pump 210, respectively. The housing 240 is designed to evenly distribute the vibrational and dynamic loads that the rotor bearing assembly imparts on the housing 240 structure during operation. The cut away in FIGS. 2D and 2E show greater details of the housing 240 around the rotary elements.

The housing 240 may include a stator, which is a stationary structure housing the pump rotor 210, and the turbine rotor 220. The housing 240 may also house electromagnetic coils that establish a magnetic coupling field 600 between the various rotodynamic components (e.g., the pump rotor 210 and turbine rotor 220).

Many types of bearing may be used in the turbopump 200. For example, rotational bearings are ubiquitous mechanical components employed to permit smooth, low-friction rotation between two parts. Rotational bearings achieve this by employing rolling or sliding elements to separate the rotating surfaces and minimize friction. Ball bearings utilize spheres (balls) rolling between inner and outer races, offering good radial and some axial load capacity. Their versatility, compactness, and minimal maintenance requirements make them widely popular. Common types include deep groove, angular contact, and self-aligning ball bearings. Roller bearings employ cylindrical, tapered, or needle rollers in place of balls. They offer substantially higher load capacity, particularly for axial loads, but often at the expense of increased size and maintenance needs. Common types include cylindrical, tapered, and needle roller bearings. Plain bearings rely on a simple sliding contact between a drive shaft and a bearing surface, often composed of bronze, PTFE, or specialized polymer materials. They are known for their quiet operation, cost-effectiveness, and compact size, but suffer from higher friction and wear, necessitating frequent lubrication and maintenance. Journal bearings are a specific type of plain bearing designed for supporting rotating shafts, commonly found in engines and machinery. They frequently employ multiple bearing pads and dedicated lubrication systems. Jewel bearings are bearings which utilize precisely machined gemstones (sapphire, ruby) as bearing surfaces. They offer exceptional wear resistance and low friction for high-precision applications like watches and gyroscopes but are costly and brittle. Thrust bearings are specialized in handling axial loads (perpendicular to the drive shaft rotation) and exist in various forms, including ball thrust and tapered roller thrust bearings. Fluid-dynamic bearings utilize pressurized fluids (gas or liquid) to create a thin film separating the surfaces, eliminating friction and wear. Fluid-dynamic bearings offer exceptional speed and precision but require complex control systems and are sensitive to contamination. Magnetic bearings utilize electromagnetic forces to levitate the rotating drive shaft, eliminating physical contact and friction. They offer ultra-low friction, high speeds, and cleanliness.

All the different variants of the turbopump 200 can use mechanical ball, roller, or other physical bearings. All the different variants of the turbopump 200 can use fluid dynamic bearings. All the different variants of the turbopump 200 can use magnetics bearings. The variants of the turbopump 200 may also be used in more complex structures such as stacked/nested turbine and pump concept.

Bearings can be open, shielded, or sealed to protect against contamination and retain lubricant. Bearings are characterized by factors like load capacity, speed rating, friction coefficient, and service life. The choice of bearing type depends on specific application requirements for load, speed, precision, environment, and cost. Given these factors a type of bearing may be selected for each specific circumstance.

A rotor is a rotational component that rises pressure head and increases flow rate through rotational work (e.g., centrifugal pump), as well as a rotational component that extracts kinetic energy to produce mechanical power (e.g., a turbine). In one embodiment the turbine 220 and pump 210 may be part of a common rotor. In a rocket engine or similar engine, the pump 210 portion directs and pressurizes liquid oxygen from the oxygen tank into cooling channels in a heat exchanger (e.g., cooling channels in a rocket nozzle), where the oxygen expands and becomes supercritical. The turbine 220 portion of the impeller (rotor) extracts energy from the supercritical oxygen and uses it to sustain the movement of the pump 210 portion of the impeller, so that it can continue to further pressurize and accelerate liquid oxygen from the tank.

Turbopumps are specialized rotary pumps employed in demanding applications where high-pressure fluid delivery is essential. They are often crucial components of liquid-fueled rocket engines, industrial high-pressure pumps, and cryogenic cooling systems. A turbopump typically includes two components with an interconnecting mechanism: a turbine 120 and a pump 110 adjoined with an interconnecting drive shaft 140 used to transfer the mechanical work from the turbine 120 to the pump 110 (see FIG. 1). The turbine 120 extracts energy from a high-pressure high-temperature fluid stream, typically hot combustion gas or hot exhaust gases from another engine, to drive the pump 110. A turbopump could also be used in power generation or other similar systems.

Two primary types of pumps are typically employed in turbopumps: centrifugal pumps and axial-flow pumps. Centrifugal pumps utilize a rotating impeller with angled blades to accelerate the fluid radially outward, converting its kinetic energy into increased pressure. They are efficient and offer high flow rates, making them suitable for various applications. Axial-flow pumps utilize a series of rotating and stationary blades to progressively add energy to the fluid, increasing its pressure along the axial direction. Axial-flow pumps are efficient for low-density fluids but may require multiple stages to achieve high pressures.

The drive shaft 140 in a conventional turbopump plays a critical role in its operation and functionality. It acts as the central spine connecting the turbine and the pump, transmitting the high-speed rotation generated by the turbine to the pump impeller. This rotation ultimately translates into the high pressure and flow rate of the propellant delivered to the rocket engine combustion chamber. The drive shaft 140 transmits the turbine's rotational power to the pump impeller, driving it at high speeds. This rapid impeller rotation is essential for generating the necessary pressure and flow of the propellant. The drive shaft 140 acts as a rigid backbone, supporting the weight and rotational forces of both the turbine and the pump. The drive shaft 140 needs to be incredibly strong and resilient to withstand immense stresses and vibrations. The drive shaft's precise design and manufacturing ensure a high degree of balance and alignment between the turbine and the pump. This balanced rotation can minimize vibration and promotes smooth, efficient operation. The integrity and efficiency of the drive shaft 140 directly impact the overall performance of the turbopump. Any imbalances or weaknesses can lead to vibration, power loss, and ultimately reduced propellant pressure and flow, compromising the engine's thrust. The turbopump operates in a harsh environment with extreme temperatures and pressures. The drive shaft's material properties and design play a crucial role in its reliability and durability under these demanding conditions. Failures in the drive shaft can have catastrophic consequences for the operation of the engine. The choice of material for the drive shaft 140 is critical. It needs to be lightweight for fuel efficiency, yet possess exceptional strength, temperature resistance, and resistance to corrosion from the propellants. Materials like high-strength steels, titanium alloys, and even advanced composites are often used. Thus, avoiding such a drive shaft has substantial benefits. Turbopumps avoiding such a drive shaft can achieve significantly higher pressures and flow rates than conventional pumps, making them highly desirable for rocket engines. Combining turbine and pump in a single unit as shown in FIGS. 2A-2F improves overall efficiency compared to separate units. Turbopumps are complex and high-precision devices requiring advanced materials, engineering, and manufacturing.

A turbopump may be used in various cycles. A fuel-rich/oxidizer-rich cycle uses separate pumps for fuel and oxidizer, each driven by its own turbine powered by the respective propellant's rich exhaust. A staged combustion cycle utilizes a single turbopump driven by hot gas from a pre-burner stage of a rocket, simplifying the design but reducing efficiency. An open cycle engine utilizes a high-pressure gas generator (GG) to drive the turbopump, powering both fuel and oxidizer pumps. Hot exhaust from the GG is directly vented overboard, not contributing to propulsion. An expander cycle engine utilizes the heated propellant itself to drive the turbopump. Propellant absorbs heat from the combustion chamber and nozzle, changing phase and expanding. This high-pressure, high-energy propellant drives the turbine before being injected into the combustion chamber for burning.

Turbopump design and operation present several challenges such as High rotational speeds, material compatibility and sealability. Turbopumps operate at extremely high speeds (tens of thousands of rpm) to achieve the required pressure levels, necessitating robust materials, advanced bearings, and precise balancing. The pump must handle high temperatures, pressures, and potentially corrosive fluids, demanding carefully chosen materials with exceptional strength and resistance. Also, preventing leakage of high-pressure fluids and gases is critical, requiring specialized sealing technologies to maintain pump efficiency and prevent contamination.

A hybrid rocket motor using a turbopump to pressurize a liquid propellent may also be implemented. A traditional turbopump 100 design using a shaft 140 between the rotodynamic components, e.g., turbine 120 to pump 110 with bearings on the drive shaft itself might be used. However, with the traditional barbell design, the operating speed necessary to produce high pressure flows subject the drive shaft to vibrational instabilities, causing the drive shaft to experience instantaneous deformation. These harmonic modes critically affect the operational stability and efficiency of the system, potentially causing catastrophic component failure. Instead by using the design of FIGS. 2A-2F greater stability and strength of the turbopump 200 can be accomplished such that the turbopump 200 can operate the necessary speeds.

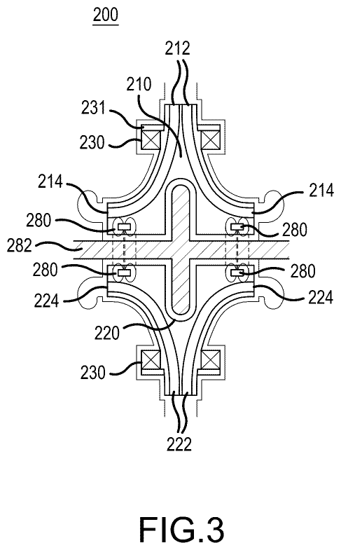

FIG. 3 is a schematic representation of a second example embodiment of a turbopump 200 produced according to the principals of the present application with a portion cut away. FIG. 3 includes the pump 210 and turbine 220 similar to FIGS. 2A-2F except that the pump 210 and turbine 220 are not connected at the fluid-dynamic seal 290 but instead are connected by magnets 280. The magnets 280 may be electromagnets or permanent magnets. The magnets 280 create a magnetic field that create a force attracting the pump 210 and the turbine 220. Each of the pump 210 and the turbine 220 may include multiple magnets (for example 4). The magnets 280 may be aligned such that a magnet 280 from pump 210 aligns with a magnet 280 from the turbine 220. First magnets on the pump impeller 211 and Second magnets on the turbine impeller 221 may be configured to magnetically couple the pump impeller 211 and the turbine impeller 221. A dividing medium 282 may be placed between the turbine 220 and the pump 210 which may create a hermetic seal between the pump 210 and the turbine 220 sealing the pump impeller 211 and the turbine impeller 211 from each other. The driving medium may include a magnetically permeable material such as a plastic, ferrous material, nickel, cobalt alloys, silicon steel, iron-silicon alloy, etc. The dividing medium 282 may not rotate with the turbine 220 and pump 210 but may allow a magnetic coupling field to pass through the dividing medium such that the turbine 220 and the pump 210 rotate together. A central bearing 232 may extend through the center of the turbine 220 and pump 210 to provide additional stability. The central bearing 232 may be any of a jewel bearing, a magnetic bearing, or a fluid bearing. The central bearing 232 and the dividing medium 282 may be connected such that the central bearing is connected to the housing 240 by the dividing medium 282.

A Magnetic coupling mechanism may be provided for hermetically sealed configurations. The magnetic coupling mechanism may consist of permanent magnet or electromagnetic devices that couple rotational devices through magnetic fields or locate rotational devices inside of the housing in a rotationally stable state.

The hermetically sealed turbopump 200 may be used as a multi-fluid turbopump in a liquid propellant rocket engine in which a plurality of rotodynamic pumping devices would be magnetically coupled to each other and a turbine(s) and or electric motor such that multiple fluids could be controlled independently. Additionally, a magnetic gearbox (discussed below) can be used to vary the rotational speed and torque between differing rotational devices.

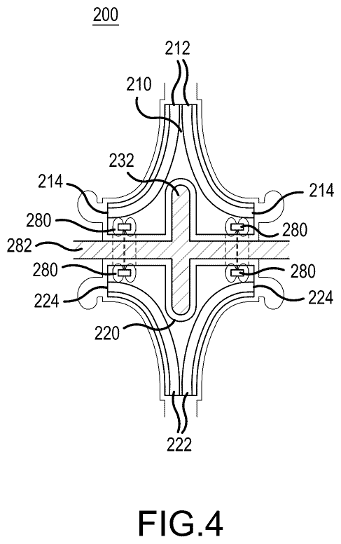

FIG. 4 is a schematic representation of a third example embodiment of a turbopump 200 produced according to the principals of the present application with a portion cut away. FIG. 4 includes the pump 210 and turbine 220 similar to FIG. 3 except that the pump 210 and turbine 220 do not include bearing 230 connected thereto. The rotation of the pump 210 and the turbine may be stabilized by the magnetic coupling mechanism pulling on the turbine impeller 221 and pump impeller 211 and the central bearing 232 providing an opposite stabilizing force on the turbine impeller 221 and pump impeller 211. In this example embodiment, the central bearing supports and stabilizes the rotation of the pump 210 and turbine 220 without the bearings 230 in the pump 210 and turbine 220.

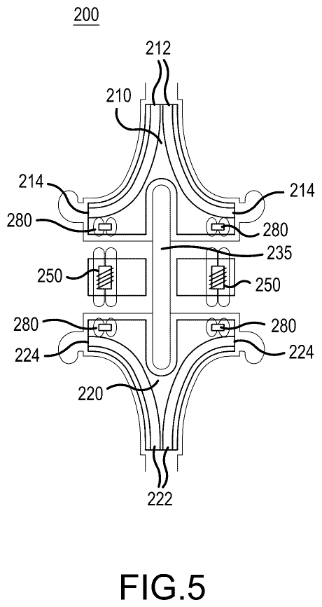

FIG. 5 is a schematic representation of a fourth example embodiment of a turbopump 200 produced according to the principals of the present application with a portion cut away. FIG. 5 includes the pump 210 and turbine 220 similar to FIG. 4 except that the dividing medium 282 is not present or additionally includes electric motor 250 with electromagnetic inductors. The rotodynamic device 200 may be driven either by the turbine 220, the electric motor 250 or a combination thereof. The electric motor 250 may be used to add an electromagnetic drag upon the rotodynamic device 200 such that work is extracted as electrical power that can be used to power other ancillary systems for later acceleration of the rotodynamic device or for deceleration of the rotodynamic device 200. Thus, the electric motor 250 can be used for dynamic control of the rotodynamic device 200 and can function as direct throttle control of the rotodynamic device 200. The electric motor 250 may be controlled by a controller (not shown) and powered by an electrical power source such as a battery (not shown).

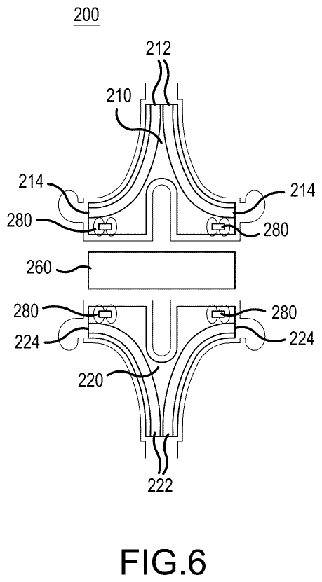

FIG. 6 is a schematic representation of a fifth example embodiment of a turbopump 200 produced according to the principals of the present application with a portion cut away. FIG. 6 includes the pump 210 and turbine 220 similar to FIG. 5 except that the electric motor 250 is replaced by or additionally includes a magnetic gearbox 260. Magnetic gearboxes offer several advantages over traditional mechanical gearboxes. Instead of relying on physical contact between gears, they use the interaction of magnetic fields to transmit torque and speed, which eliminates friction, lubrication, and wear and tear, leading to a variety of benefits. A magnetic gearbox 260 may interact with the magnets 280 arranged on pump 210 and turbine 220. These pump 210 and turbine 220 can operate with the magnetic gearbox 260 either coaxially (aligned along the same axis as shown in FIG. 6) or orthogonally (perpendicular). The magnetic gearbox 260 may be a coaxial magnetic gearbox or an orthogonal magnetic gearbox. A coaxial magnetic gearbox includes an inner and an outer rotor, both equipped with magnets facing each other. As the inner rotor rotates, its magnetic field interacts with the magnetic field of the outer rotor, inducing magnetic attraction and repulsion. This interaction creates a torque on the outer rotor, causing it to rotate in the same direction as the inner rotor but at a different speed. The ratio of these speeds depends on the number of magnetic poles on each rotor. An orthogonal magnetic gearbox includes rotors positioned at right angles from each other. The magnetic field from one rotor induces eddy currents in the conductive plate of the other rotor. These eddy currents, in turn, generate a magnetic field that interacts with the first rotor's field, creating torque and causing the second rotor to spin.

Magnetic gearboxes offer several advantages over traditional gearboxes. The absence of physical contact eliminates most friction, leading to higher efficiency, lower energy consumption, and reduced heat generation. Without any gears grinding against each other, no lubrication is required, resulting in reduced maintenance and environmental benefits. The lack of friction also minimizes wear and tear, extending the lifespan of the gearbox. Magnetic gearboxes can achieve high levels of precision due to the well-defined interaction between magnetic fields. The magnetic field naturally limits the torque transmission, providing inherent overload protection. No lubricants or wear debris mean cleaner operation and compatibility with sensitive environments.

A turbopump may be used to reduce load from axial force using common impeller. With traditional designs the turbopump is shrouded and bearing locations are difficult to work with when traditional machining is used. By using additive manufacturing and the design of FIGS. 2A-6, an integral shroud may be used to overcome friction losses that other designs would see in the same operational state. The bearing being on the turbine and pump rather than on the drive shaft 140 also improves ease manufacturing (especially with additive manufacturing). The mathematically driven nonstandard geometries of the structures of FIGS. 2A-6, which are only possible with additive manufacturing, allow for these advantages. The turbine 220 may include an integral turbine impeller manufactured with additive manufacturing. The integral turbine impeller being the portion of the turbine 220 that rotates. The pump 210 may include an integral pump impeller manufactured with additive manufacturing. The integral pump impeller being the portion of the pump 210 that rotates.

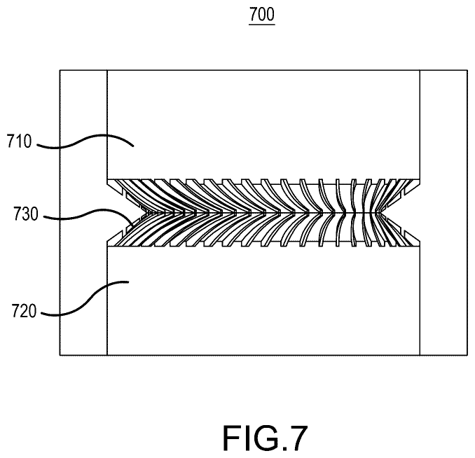

FIG. 7 is a schematic representation of a housing 700 for rotodynamic components produced according to the principals of the present application. The rotodynamic components (e.g., turbine 220, pump 210, and bearings 230) may be housed in the housing 700. The housing 700 may include a first portion 710 and a second portion 720 at midspan between the turbine 220 and pump 210 may include a passive hydrodynamic seal (rotodynamic seal) 730 which uses the rotation of the turbine 220 and pump 210 to pump fluid back toward each respective impeller (e.g., turbine 220, pump 210). The passive hydrodynamic seal 730 includes teeth which define grooves which are oriented in the opposite direction of the rotors spin. The skin friction of the rotor spinning induces the fluid to pump in the direction of the teeth. Such rotodynamic seals are generally known but according to the teachings of the present application may be desirably used in a turbopump, particularly one used within a rocket propulsion system.

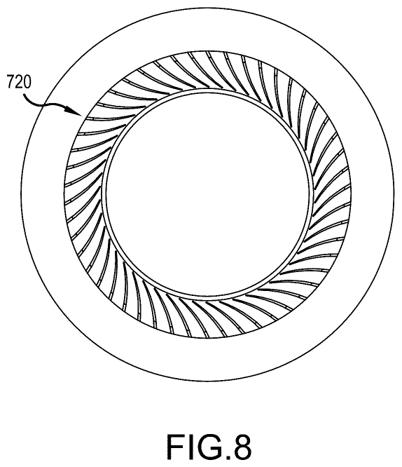

FIG. 8 is a schematic representation of the housing 700 for rotodynamic components produced according to the principals of the present application. FIG. 8 represents a cross section view (top down from the perspective of FIG. 7) of the housing 700 at the midpoint. The rotodynamic components rotate counterclockwise from the perspective of FIG. 8 inside the housing 700. This places the teeth in opposition of the flow forcing the fluid outwardly centrifugally.

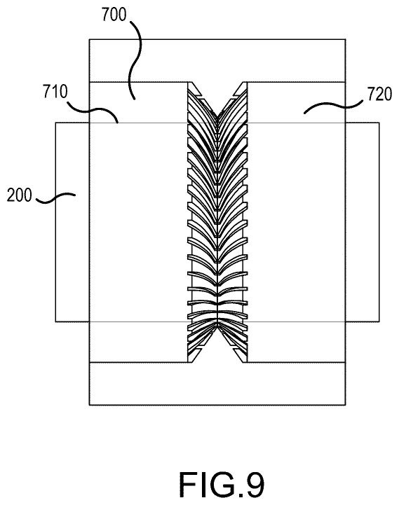

FIG. 9 is a representation of the housing 700 for rotodynamic components with the rotodynamic device 200 inside the housing 700 produced according to the principals of the present application. Only a portion of the housing 700 for ease in seeing the representation of the rotodynamic device 200 inside the device. The housing 700 may enclose substantially all of the rotodynamic device 200 (e.g., inlets and outlets of the rotodynamic device 200 may extend out of the housing 700).

It should be apparent that the examples described above are exemplary and that the scope of the invention is defined solely by the appended claims which describe the invention and include such modifications that would occur to one of ordinary skill in the art.

What is claimed is:

1. A turbopump assembly in a rocket propulsion system, the turbopump assembly comprising:
a rotor with at least one integral pump impeller and at least one integral turbine impeller;
a housing containing the rotor; and
first and second bearings supporting the rotor, the first and second bearings being supported by the housing, wherein
the rotor is disposed between the first and second bearings such that the at least one integral pump impeller and the at least one integral turbine impeller are supported between the first and second bearings, and
the at least one integral pump impeller and at least one integral turbine impeller are between all bearings supporting the pump and turbine in the housing.

2. The turbopump assembly of claim 1, wherein the at least one integral pump impeller and the at least one integral turbine impeller are fixed directly to each other and rotate at the same rotational velocity.

3. The turbopump assembly of claim 1, further comprising:
a rotodynamic seal configured to use the rotation of the rotor to pump fluid from a boundary region between a pump fluidic region and a turbine fluidic region.

4. A rotodynamic component in a rocket propulsion system, the pump turbine assembly comprising:
a rotor including a pump with a pump impeller and a turbine with a turbine impeller; and
a housing supporting the rotor, wherein
the turbine impeller is arranged such that energy of rotation of the turbine impeller is imparted directly to the pump impeller without any intermediary rotational device positioned therebetween.

5. The rotodynamic component of claim 4, further comprising:
first bearings between the pump impeller and the housing and second bearings between the turbine impeller and the housing, the first and second bearings being configured to support the pump impeller and the turbine impeller while allowing rotation of the pump impeller and the turbine impeller.

6. The rotodynamic component of claim 5, wherein the pump and turbine impellers are coupled by a magnetic coupling.

7. The rotodynamic component of claim 5, wherein the rotor is supported by bearings, wherein each of the bearings is positioned within one of the pump impeller and the turbine impeller.

8. The rotodynamic component of claim 5, further comprising:
a motor between the pump and turbine and magnetically coupled to the pump impeller and turbine impeller.

9. The rotodynamic component of claim 5, further comprising:
a magnetic gearbox between the pump and turbine and magnetically coupled to the pump impeller and turbine impeller, wherein the magnetic gearbox is one of a coaxial magnetic gearbox and an orthogonal gearbox.

10. A pump turbine assembly in a rocket propulsion system, the pump turbine assembly comprising:
a rotor including a pump with a pump impeller and a turbine with a turbine impeller; and
a housing containing the rotor, wherein
the pump and turbine impellers are interconnected to each other to translate rotation therebetween without a drive shaft positioned therebetween.

11. The pump turbine assembly of claim 10, further comprising:
a magnetic bearing coupling the pump impeller and turbine impeller,
wherein the pump impeller and the turbine impeller are magnetically coupled to rotate at different rotational velocities.

12. The pump turbine assembly of claim 10 further comprising:
a hermetic seal sealing the pump impeller and turbine impeller from each other.

13. The pump turbine assembly of claim 10, further comprising:
first magnets on the pump impeller and second magnets on the turbine impeller, wherein the first magnets and the second magnets are configured to magnetically couple the pump impeller and the turbine impeller.

14. The pump turbine assembly of claim 10 wherein the pump and turbine impellers rotate on bearings between the housing and rotor, and each bearing is positioned on one of the pump impeller and the turbine impeller.

15. The pump turbine assembly of claim 14, wherein the pump and turbine impellers are coupled by a magnetic coupling.

16. The pump turbine assembly of claim 14, wherein the sole bearings supporting the pump and turbine impellers are positioned on the pump and turbine impellers.

17. The pump turbine assembly of claim 14, further comprising:
a motor between the pump and turbine and magnetically coupled to the pump impeller and turbine impeller.

18. The pump turbine assembly of claim 14, further comprising:
a magnetic gearbox between the pump and turbine and magnetically coupled to the pump impeller and turbine impeller, wherein the magnetic gearbox is one of a coaxial magnetic gearbox and an orthogonal gearbox.
